(19) United States
(12) Patent Application Publication
(10) Pub. No.: US 2024/0039292 A1
(43) Pub. Date: Feb. 1, 2024

(54) ENERGY DISTRIBUTION SYSTEM

(71) Applicant: Heart Aerospace AB, Göteborg (SE)

(72) Inventors: Luis Antonio Aguilera Medina, Göteborg (SE); Bassem Farag, Hisings Backa (SE); Fabrício DE OLIVEIRA SPIGOLON, Kungälv (SE)

(21) Appl. No.: 18/361,618

(22) Filed: Jul. 28, 2023

(30) Foreign Application Priority Data
Jul. 29, 2022 (SE) 2250933-5

(51) Int. Cl. H02J 3/38; H02J 1/10

(52) U.S. Cl. CPC H02J 3/381; H02J 1/102; H02J 2207/20; H02J 2310/44

(57) ABSTRACT

The present invention relates to an energy distribution system (20) for an aircraft with at least two electrical powertrain units, each comprising a propulsion unit (1) powered by energy storage units (13) each configured to supply a first direct current, DC, voltage. The energy distribution system (20) comprises at least one converter unit (25) configured to energize a DC bus (16) having a lower DC voltage than the first DC voltage provided from each respective energy storage unit (13), each converter unit (25; 35) comprises a DC/DC converter arrangement (21) configured to convert the first DC voltage from at least one energy storage units (13) to a second DC voltage on the DC bus (16), and a DC bus battery (22) with a nominal operating DC voltage of the second DC voltage. The DC bus (16) provides energy for charging the DC bus battery (22) when energized from the energy storage units (13), and the DC bus battery (22) supply energy to the DC bus (16) when the energy storage units fail to energize the DC bus (16).

### TECHNICAL FIELD

The present disclosure relates to an energy distribution system configured to create a common DC bus on an aircraft having enhanced stability. It further relates to an aircraft comprising the energy distribution system.

### BACKGROUND

The essential systems in an electric aircraft rely on a continuous supply of electric power and energy to function properly. This may be achieved with multiple redundant energy sources for each system, or by one or more common direct current (DC) buses to distribute energy to critical systems. FIG. 1 shows a prior art system where a common high voltage DC bus is used to power the propulsion units and a DC/DC converter is provided to create a common low voltage DC bus from which critical and non-critical loads are powered.

A drawback with the prior art system is that the DC voltage on the common low voltage DC bus may experience voltage spikes or even shut down if the common high voltage DC bus fails to energize the common low voltage DC bus.

Thus, there is a need for a more stable and secure supply of energy to energize a low voltage DC bus.

### SUMMARY

An object of the present disclosure is to provide an energy distribution system which seeks to mitigate, alleviate, or eliminate one or more of the above-identified deficiencies in the art and disadvantages singly or in any combination.

This object is obtained by an energy distribution system for an aircraft with at least two electrical powertrain units, each powertrain unit comprises a propulsion unit powered by an energy storage unit configured to supply a first direct current, DC, voltage via a DC connection to the propulsion unit. The first DC voltage supplied by the energy storage unit in each powertrain unit varies depending on state of charge and the power demand from the connected propulsion unit. The energy distribution system comprises at least one converter unit configured to energize a DC bus having a lower DC voltage than the first DC voltage provided from each respective energy storage unit. Each converter unit of the at least one converter unit comprises: a DC/DC converter arrangement configured to convert the first DC voltage from each energy storage unit to a second DC voltage on the DC bus; and a DC bus battery with a nominal operating DC voltage of the second DC voltage. The DC bus provides energy for charging the DC bus battery when energized from the energy storage units, and the DC bus battery supply energy to the DC bus when the energy storage units fail to energize the DC bus.

An advantage with the present invention is that a more stable low voltage DC bus may be obtained compared to prior art solutions since the DC bus battery also helps on transients.

Another advantage with the present invention is that emergency power may be obtained by the DC bus battery in case the energy storage units fail to energize the DC bus.

Further aspects and advantages may be obtained from the detailed description.

### BRIEF DESCRIPTION OF THE DRAWINGS

The foregoing will be apparent from the following more particular description of the example embodiments, as illustrated in the accompanying drawings in which like reference characters refer to the same parts throughout the different views. The drawings are not necessarily to scale, emphasis instead being placed upon illustrating the example embodiments.

FIG. 1 shows an energy distribution system for providing a low voltage DC bus in an aircraft according to prior art;

FIG. 2 shows an energy distribution system for providing a low voltage DC bus in an aircraft according to a first example embodiment;

FIG. 3 shows an energy distribution system for providing multiple low voltage DC buses in an aircraft according to a second example embodiment;

FIG. 4 shows an energy distribution system for providing multiple low voltage DC buses in an aircraft according to a third example embodiment;

FIG. 5 shows an energy distribution system with a control unit for providing low voltage DC buses according to a fourth embodiment; and

FIG. 6 is a flowchart illustrating a method to energize the low voltage DC buses.

### DETAILED DESCRIPTION

Aspects of the present disclosure will be described more fully hereinafter with reference to the accompanying drawings. The system disclosed herein can, however, be realized in many different forms and should not be construed as being limited to the aspects set forth herein. Like numbers in the drawings refer to like elements throughout.

The terminology used herein is for the purpose of describing particular aspects of the disclosure only and is not intended to limit the invention. As used herein, the singular forms “a”, “an” and “the” are intended to include the plural forms as well, unless the context clearly indicates otherwise.

Some of the example embodiments presented herein are directed towards an energy distribution system intended to be used in an aircraft, such as an aeroplane (airplane), helicopter, or other machine capable of flight whether manned or unmanned.

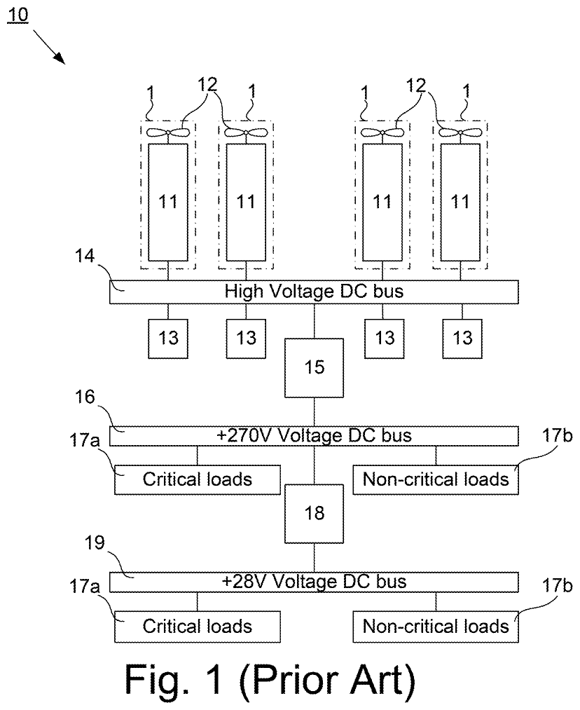

FIG. 1 shows an energy distribution system 10 for providing a low voltage DC bus in an aircraft according to prior art. In this aspect, the wording “low voltage DC bus” is exemplified as a 270V DC bus that may be used to power critical and non-critical loads in an aircraft. Other voltages may be used depending on the actual implementation of system components.

In FIG. 1, the energy distribution system 10 comprises four propulsion units 1 powered by four energy storage units 13 via a common high voltage DC bus 14. Each propulsion unit 1 comprises a drive unit 11 (with an alternate current (AC) electric motor that receives power via a DC/AC inverter from the common high voltage DC bus 14) and a propeller 12. The energy storage units 13 may comprise rechargeable batteries or battery packs. The voltage on the common high voltage DC bus 14 varies, as an example between 480-800 VDC, depending on state of charge and the power demand from the connected propulsion units 1.

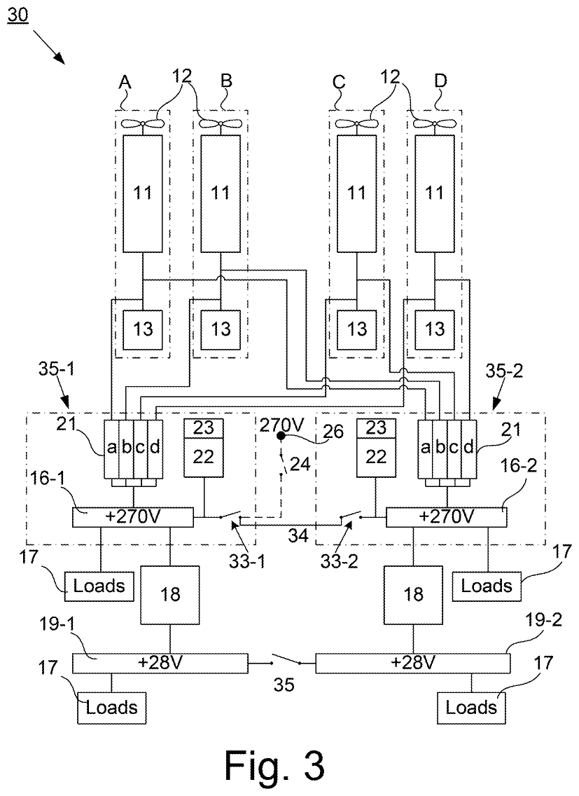

A DC/DC converter 15 is provided to energize a common 270 VDC bus 16, which supplies power to critical loads 17a and non-critical loads 17b that operates on 270 VDC. A further DC/DC converter 18 is provided to energize a common 28 VDC bus 19 that supplies power to critical loads 17a and non-critical loads 17b that operate on 28 VDC. Loads are commonly denoted 17, as in FIG. 3, and include both critical and non-critical loads.

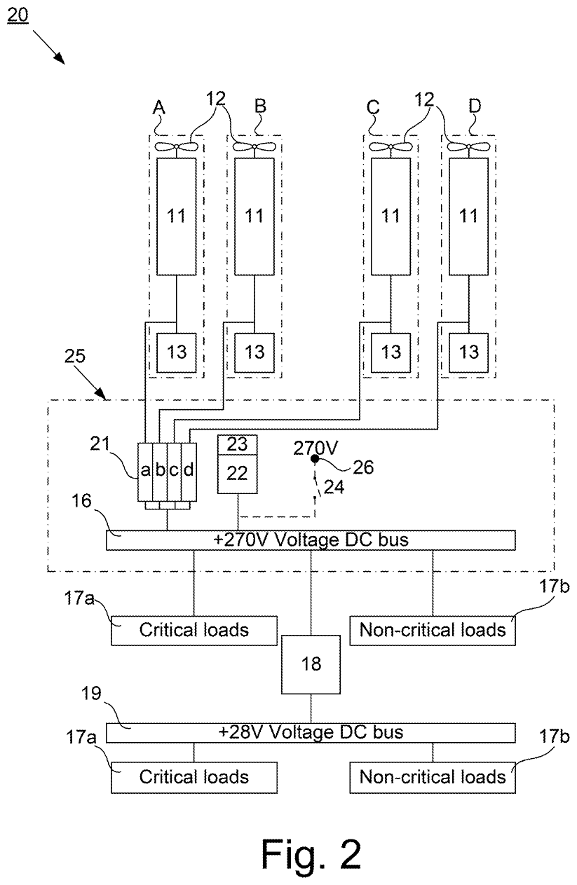

FIG. 2 shows an energy distribution system 20 for providing a low voltage DC bus, e.g. 270 VDC, in an aircraft according to a first example embodiment of the invention. The energy distribution system comprises a plurality of powertrain units, in this example four powertrain units A, B, C and D. Each powertrain unit comprises a propulsion unit and an energy storage unit 13. The propulsion unit comprises a drive unit 11 and a propeller 12. The drive unit 11 comprises an alternating current (AC) electric motor and a DC/AC inverter. The DC/AC inverter receives DC power from the energy storage unit 13 and provides AC power to the electric motor. In some examples, the electric motor is an induction motor and the DC/AC inverter is a variable frequency inverter. The energy storage unit 13 is configured to supply a first direct current, DC, voltage via a DC connection to the drive unit 11 in the propulsion unit. The first DC voltage supplied by the energy storage unit 13 in each powertrain unit varies depending on state of charge and the power demand from the connected propulsion unit, and as an example the first DC voltage may vary between 480-800 VDC.

The energy distribution system 20 further comprises a converter unit 25 configured to energize a DC bus 16 having a lower DC voltage, e.g. 270 VDC, than the first DC voltage, e.g. 480-800 VDC, provided from each respective energy storage unit 13. The converter unit 25 comprises: a DC/DC converter arrangement 21 configured to convert the first DC voltage from each energy storage unit 13 to a second DC voltage on the DC bus 16; and a DC bus battery 22 with a nominal operating DC voltage of the second DC voltage.

The energy distribution system may comprise an external input 26 configured to provide energy to the DC bus 16 using an external connection when the aircraft is on the ground, provided a switch 24 is closed. The switch 24 may be controlled by a controller (not shown) or be a manually activated switch.

The DC/DC converter arrangement 21 comprises four separate DC/DC converters a-d, one for each energy storage unit 13. The energy storage unit of powertrain “A” is connected to DC/DC converter “a”, the energy storage unit of powertrain “B” to DC/DC converter “b”, and so on. The output from the separate DC/DC converters a-d are jointly connected to the DC bus 16.

The DC bus battery 22 is controlled by a battery management unit (BMU) 23 that is powered by the DC bus battery 22 through an internal DC/DC converter inside the DC bus battery 22. Furthermore, the DC bus battery 22 may be configured to power up the DC bus 16 when starting the aircraft.

The DC bus 16 provides energy for critical loads 17a and non-critical loads 17b that operate on 270 VDC, as well as providing energy for charging the DC bus battery 22 when energized from the energy storage units 13. The DC bus battery 22 is also configured to supply energy to the DC bus 16 when the energy storage units 13 fail to energize the DC bus 16 through DC/DC converter arrangement 21. This may occur due to depletion of charge in the energy storage unit 13. Furthermore, the DC bus battery also helps to provide a stable DC voltage level if voltage spikes, or sudden surges occur from the connected loads 17. A further DC/DC converter 18 is in this embodiment provided to energize a common 28 VDC bus 19 that supplies power to critical loads 17a and non-critical loads 17b that operate on 28 VDC.

FIG. 3 shows an energy distribution system 30 for providing multiple low voltage DC buses, e.g. 270 VDC, in an aircraft according to a second example embodiment. The energy distribution system 30 differs from the system described in connection with FIG. 2 in one major aspect. Instead of using one converter unit 25, the energy distribution system 30 comprises two converter units, a first converter unit 35-1 and a second converter unit 35- and each converter unit is configured to energize a separate DC bus 16-1, 16-2. In some embodiments, first converter unit 35-1 is identical to second converter unit 35-2.

Each converter unit 35-1, 35-2 comprises a DC/DC arrangement 21 to energize the separate DC bus 16 and a DC bus battery 22 with a BMU 23. Furthermore, each converter unit 35-1, 35-2 also comprises a switch 33-1 and 33-2, respectively, which together are used to connect the separate DC buses with each other via an interconnection 34.

The energy distribution system 30 may comprise an external input 26 configured to provide energy to the DC buses 16-1, 16-2 using an external connection when the aircraft is on the ground, provided switches 24 and 33 are closed. The switches 24 and 33 may be controlled by a controller (not shown) and/or be manually activated switches.

In this embodiment, each DC/DC converter arrangement 21 comprises a separate DC/DC converter a-d for each energy storage unit 13 and each energy storage unit 13 is connected to two independent DC/DC converter arrangements 21.

Each DC bus 16 provides energy for loads 17 (which may be critical loads and/or non-critical loads) that operate on 270 VDC, as well as providing energy for charging each DC bus battery 22 when energized from the energy storage units 13 via the DC/DC converters a-d. The DC bus battery 22 is also configured to supply energy to each DC bus 16 when the energy storage units 13 fail to energize the DC bus 16 through DC/DC converter arrangement 21. Furthermore, the DC bus battery also helps to provide a stable DC voltage level if voltage spikes, or sudden surges occur from the connected loads 17. A separate DC/DC converter 18 is in this embodiment connected to each 270V DC bus 16 to energize a separate 28 VDC bus 19-1 and 19-2 that supplies power to loads 17 (which may be critical loads and/or non-critical loads) that operate on 28 VDC. A switch 35 is provided between the 28 VDC buses to create a common 28 VDC bus when closed. The switch 34 may be controlled by a controller (not shown) and/or be a manually activated switch.

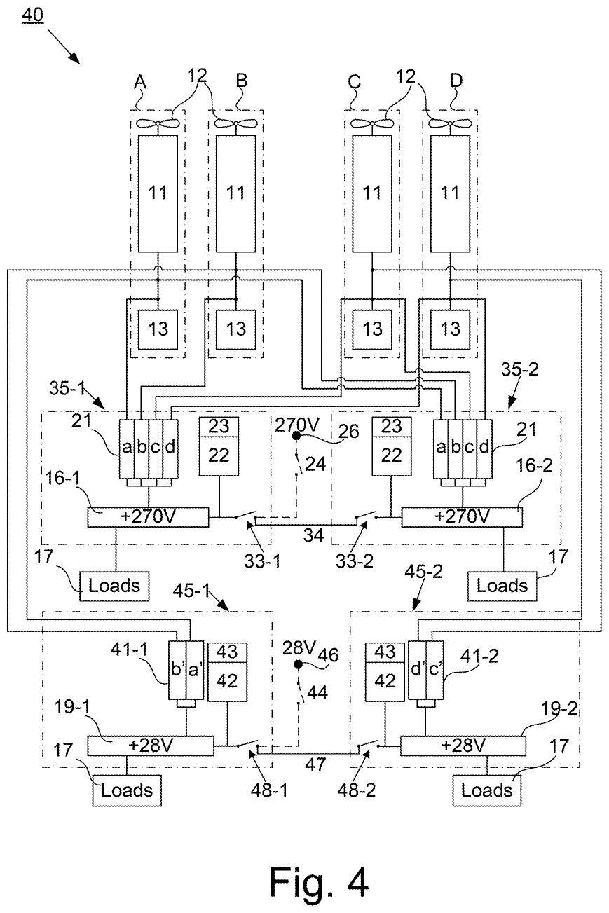

FIG. 4 shows an energy distribution system 40 for providing multiple low voltage DC buses, e.g. 270 VDC and/or 28 VDC, in an aircraft according to a third example embodiment. The energy distribution system 40 differs from the system described in connection with FIG. 3 in one major aspect. Instead of using separate DC/DC converters 18 to energize the 28 VDC buses 19-1, 19-2 from each 270 VDC bus 16-1, 16-2, the energy distribution 40 comprises two additional converter units, a first converter unit 45-1 and a second converter unit 45-2 which are configured to energize each DC bus 19-1, 19-2.

Each additional converter unit 45-1, 45-2 comprises a DC/DC arrangement 41-1, 41-2 to energize each 28 VDC bus 19-1, 19-2 and a low voltage DC bus battery 42 with a BMU 43. Furthermore, each converter unit 45-1, 45-2 also comprises a switch 48-1 and 48-2, respectively, which together are used to connect the separate 28 VDC buses with each other via an interconnection 47.

The energy distribution system 40 may further comprise an external input 46 configured to provide energy to the DC buses 19-1, 19-2 using an external connection when the aircraft is on the ground, provided switches 44 and 48-1, 48-2 are closed. The switches 44 and 48-1, 48-2 may be controlled by a controller (not shown) and/or be manually activated switches.

In this embodiment, the first DC/DC converter arrangement 41-1 comprises separate DC/DC converters a′ and b′ connected to two energy storage units 13 in powertrain units A and B and the second DC/DC converter arrangement 41-2 comprises separate DC/DC converters c′ and d′ connected to two energy storage units 13 in powertrain units C and D.

Each DC bus 19 provides energy for loads 17 (which may be critical loads and/or non-critical loads) that operate on 28 VDC, as well as providing energy for charging each low voltage DC bus battery 42 when energized from the energy storage units 13. The low voltage DC bus battery 42 is also configured to supply energy to each 28 VDC bus 19-1, 19-2 when the energy storage units 13 fail to energize the 28 VDC bus 191-, 19-2. Furthermore, the low voltage DC bus battery also helps to provide a stable 28 VDC voltage level if voltage spikes, or sudden surges occur from the connected loads 17a, 17b.

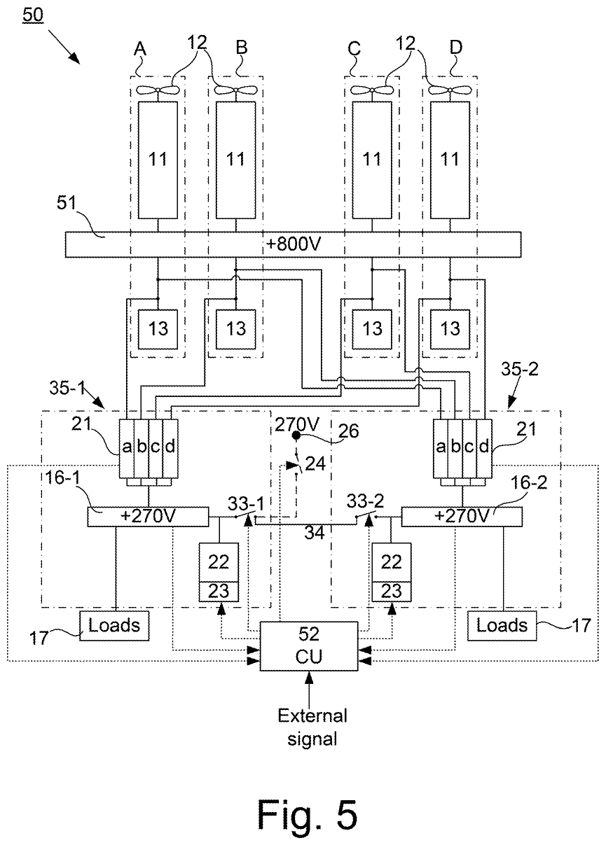

FIG. 5 shows an energy distribution system 50 for providing a low voltage DC bus, e.g. 270 VDC, in an aircraft according to a fourth example embodiment. The energy distribution system 50 differs from the system described in connection with FIG. 4 in one major aspect. The propulsion units 1 are connected to a common high voltage DC bus 51, and the energy storage units 13 are connected to energize the common high voltage DC bus 51, which have a voltage that may vary between 480-800 VDC. A common high voltage DC bus may be included in any of the previous described embodiments without deviating from the inventive concept. Also, the 28 VDC buses are omitted in FIG. 5.

In addition, FIG. 5 illustrates a control unit 52 configured to control the switches 33-1, 33-2 and optionally switch 24. The control unit 52 may also be configured to control the additional switches 44, 48-1 and 48-2 arranged in relation to the 28 VDC buses in FIG. 4. The control unit 52 monitors the status of the DC/DC converters 21 and senses the voltage level of each 270 VDC bus 16-1, 16-2 via a voltage sensor (not shown). If any of the voltage sensors indicate a drop in voltage level, or the monitored status of the DC/DC converters will affect the voltage level of the DC bus, the DC bus battery 22 may be used to energize the DC bus and also to stabilize the voltage level in case there is a disturbance, e.g. voltage spikes, surges. In addition, the control unit 52 may interconnect the low voltage DC buses by closing the switches 33-1, 33-2 if one of the low voltage DC buses experiences a drop in voltage level. The control unit may also be controlled by an external signal, e.g. from the pilot or the flight control computer, if needed.

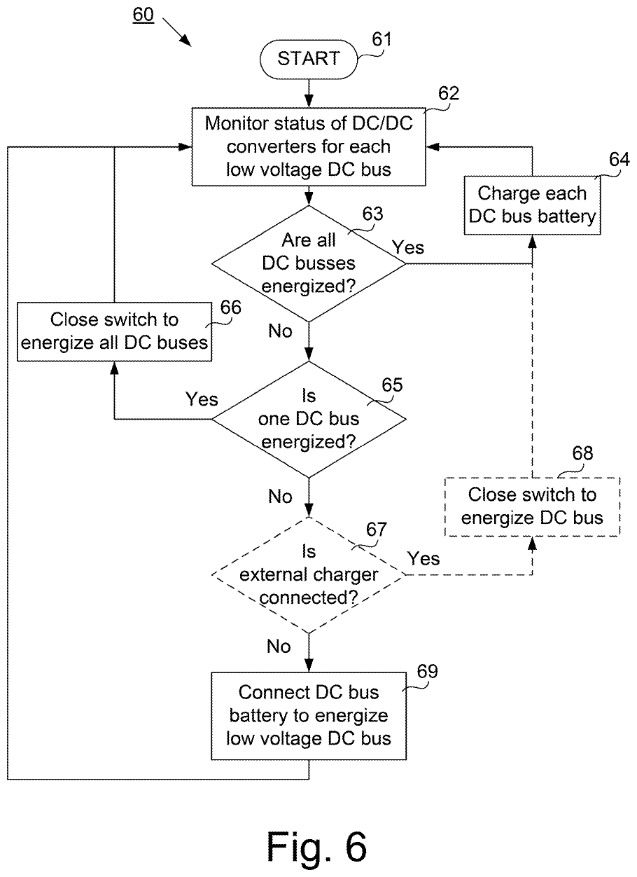

FIG. 6 is a flow chart 60 illustrating an example embodiment of the operation that may be performed by the control unit 52 in FIG. 5. The flow starts in 61, and in step 62 the control unit monitors the status of each low voltage DC bus to determine whether all DC buses are energized. In some embodiments, this is done by monitoring the status of the DC/DC converters.

In some embodiments, determining whether each low voltage DC bus is energized includes sensing the voltage level of each low voltage DC bus. In some embodiments, a combination of monitoring the status of the DC/DC converters and sensing DC bus voltage is performed. If all DC/DC converters are operational and all DC busses are energized, step 63, the flow returns to step 62 via step 63, indicating that each DC bus battery is charged while each low voltage DC bus is energized. However, if the control unit detects that one of the low voltage DC buses is non-energized the flow continues to step 65. If one of the low voltage DC buses is energized, step 65, the control unit closes the interconnecting switches 33-1, 33-2 to energize the other low voltage DC bus, step 66. If no DC bus is energized, the flow continues to step 69, where each low voltage DC bus is energized from its associated DC bus battery. The flow is thereafter fed back to step 62.

The flow chart also comprises an optional step 67 between step 65 and step 69, if the system comprises an external charger that is connected with a nominal voltage adapted to the voltage level of the low voltage buses, step 67, the flow continues to step 68 in which the charging switch 24 and one or both the interconnecting switches 33-1 and 33-2 are closed to energize one or both of the DC buses. The flow is thereafter fed back to step 62 via step 64.

The present invention relates to an energy distribution system for an aircraft with at least two electrical powertrain units. Each powertrain unit comprises a propulsion unit powered by energy storage units, each energy storage unit is configured to supply a first direct current, DC, voltage via a DC connection to the propulsion unit. The first DC voltage supplied by the energy storage unit in each powertrain unit varies depending on state of charge and the power demand from the connected propulsion unit. The energy distribution system comprises at least one converter unit configured to energize a DC bus having a lower DC voltage than the first DC voltage provided from each respective energy storage unit. Each converter unit of the at least one converter unit comprises:
a DC/DC converter arrangement configured to convert the first DC voltage from at least one of the energy storage units to a second DC voltage on the DC bus; and
a DC bus battery with a nominal operating DC voltage of the second DC voltage.

The DC bus provides energy for charging the DC bus battery when energized from the at least one energy storage unit, and the DC bus battery supply energy to the DC bus when the at least one energy storage unit fails to energize the DC bus.

According to some embodiments, the energy distribution system further comprises an external input configured to provide energy to the DC bus of each converter unit via one or more switches.

According to some embodiments, the at least one converter unit comprises a first converter unit and a second converter unit, each converter unit is configured to energize a separate DC bus.

According to some embodiments, the separate DC buses are configured to be connected via one or more switches.

According to some embodiments, each DC/DC converter arrangement comprises a separate DC/DC converter for each of the at least one energy storage unit.

According to some embodiments, when the energy distribution system comprises a first and a second converter unit, each of the at least one energy storage unit is connected to two independent DC/DC converter arrangements.

According to some embodiments, the DC bus battery is controlled by a BMU powered by the DC bus battery. This may be achieved through an internal DC/DC converter within the bus battery.

According to some embodiments, the DC bus battery is configured to power up the DC bus when starting the aircraft.

According to some embodiments, each propulsion unit comprises a DC/AC inverter, an electric motor, and a propeller.

According to some embodiments, the DC/DC converter arrangement is configured to convert the first DC voltage from each of the energy storage units to the second DC voltage on the DC bus.

According to some embodiments, each electric propulsion unit is powered by one energy storage unit.

According to some embodiments, each electric propulsion unit is powered by the energy storage units via a common DC bus.

The invention also relates to an electric aircraft comprising an energy distribution system according to any of the items above.

The invention also relates to a method for controlling an energy distribution system mentioned above, wherein the method comprises the steps to:
monitor the status of DC/DC converters converting the first DC voltage to the second DC voltage when energizing the DC bus;
if the DC/DC converters are operational, then charge each DC bus battery via the DC bus; and
if one DC bus is non-energized, then connect the DC bus battery to energize the DC bus

According to some embodiments, the at least one converter unit of the energy distribution system comprises a first converter unit and a second converter unit, each converter unit is configured to energize a separate DC bus, and at least one DC/DC converter is detected to malfunction. The method further comprises the step to connect an energized DC bus with a non-energized DC bus by closing one or more switches.

In the drawings and specification, there have been disclosed exemplary aspects of the disclosure. However, many variations and modifications can be made to these aspects without substantially departing from the principles of the present disclosure. Thus, the disclosure should be regarded as illustrative rather than restrictive, and not as being limited to the particular aspects discussed above. Accordingly, although specific terms are employed, they are used in a generic and descriptive sense only and not for purposes of limitation.

The description of the example embodiments provided herein have been presented for purposes of illustration. The description is not intended to be exhaustive or to limit example embodiments to the precise form disclosed, and modifications and variations are possible in light of the above teachings or may be acquired from practice of various alternatives to the provided embodiments. The examples discussed herein were chosen and described in order to explain the principles and the nature of various example embodiments and its practical application to enable one skilled in the art to utilize the example embodiments in various manners and with various modifications as are suited to the particular use contemplated. It should be appreciated that the example embodiments presented herein may be practiced in any combination with each other.

1. An energy distribution system (20; 30; 40; 50) for an aircraft with at least two electrical powertrain units (A-D), each powertrain unit comprises a propulsion unit (1) powered by energy storage units (13), each energy storage unit is configured to supply a first direct current, DC, voltage via a DC connection to the propulsion unit, the first DC voltage supplied by the energy storage unit (13) in each powertrain unit varies depending on state of charge and the power demand from the connected propulsion unit (1), wherein the energy distribution system (20; 30; 40; 50) comprises at least one converter unit (25; 35; 45) configured to energize a DC bus (16; 19) having a lower DC voltage than the first DC voltage provided from each respective energy storage unit (13), each converter unit of the at least one converter unit (25; 35; 45) comprises:
a DC/DC converter arrangement (21; 41-1, 41-2) configured to convert the first DC voltage from at least one of the energy storage units (13) to a second DC voltage on the DC bus (16; 19); and
a DC bus battery (22; 42) with a nominal operating DC voltage of the second DC voltage; wherein the DC bus (16; 19) provides energy for charging the DC bus battery (22; 42) when energized from the at least one energy storage unit (13), and the DC bus battery (22; 42) supply energy to the DC bus (16; 19) when the at least one energy storage unit fails to energize the DC bus (16; 19).

2. The energy distribution system according to claim 1, further comprising an external input (26; 46) configured to provide energy to the DC bus (16; 19) of each converter unit (25, 35; 45) via one or more switches (24, 33-1, 33-2; 44, 48-1, 48-2).

3. The energy distribution system according to claim 1, wherein the at least one converter unit comprises a first converter unit (35-1; 45-1) and a second converter unit (35-2; 45-2), each converter unit is configured to energize a separate DC bus (16-1, 16-2; 19-1, 19-2).

4. The energy distribution system according to claim 3, wherein the separate DC buses (16-1, 16-2; 19-1, 19-2) are configured to be connected via one or more switches (33-1, 33-2; 48-1, 48-2).

5. The energy distribution system according to claim 1, wherein each DC/DC converter arrangement (21; 41-1, 41-2) comprises a separate DC/DC converter (a-d; a′-d′) for each of the at least one energy storage unit (13).

6. The energy distribution system according to claim 5, wherein each of the at least one energy storage unit (13) is connected to two independent DC/DC converter arrangements (21).

7. The energy distribution system according to claim 1, wherein the DC bus battery (22; 42) is controlled by a BMU (23; 43) powered by the DC bus battery (22; 42).

8. The energy distribution system according to claim 7, wherein the DC bus battery (22; 42) is configured to power up the DC bus (16; 19) when starting the aircraft.

9. The energy distribution system according to claim 1, wherein each propulsion unit comprises a DC/AC inverter, an electric motor, and a propeller (12).

10. The energy distribution system according to claim 1, wherein the DC/DC converter arrangement (21) is configured to convert the first DC voltage from each of the energy storage units (13) to the second DC voltage on the DC bus (16).

11. The energy distribution system according to claim 1, wherein each electric propulsion unit (1) is powered by one energy storage unit (13).

12. The energy distribution system according to claim 1, wherein each electric propulsion unit (1) is powered by the energy storage units (13) via a common DC bus (51).

13. An electric aircraft comprising an energy distribution system according to claim 1.

14. A method for controlling an energy distribution system according to claim 1, wherein the method comprises the steps to:
monitor (62) the status of DC/DC converters converting the first DC voltage to the second DC voltage when energizing the DC bus;
if the DC/DC converters are operational (63), then charge (64) each DC bus battery via the DC bus; and
if one DC bus is non-energized (65), then connect (69) the DC bus battery to energize the DC bus.

15. The method according to claim 14, wherein the at least one converter unit of the energy distribution system comprises a first converter unit and a second converter unit, each converter unit is configured to energize a separate DC bus, and wherein at least one DC/DC converter is detected to malfunction (65), and the method further comprises the step to connect an energized DC bus with a non-energized DC bus by closing (66) one or more switches.
